(19) United States
(12) Patent Application Publication
(10) Pub. No.: US 2026/0065123 A1
(43) Pub. Date: Mar. 5, 2026

(54) DYNAMIC MEDIATION OF ACCESS TO QUANTUM SERVICES

(71) Applicant: Red Hat, Inc., Raleigh, NC (US)

(72) Inventors: Leigh Griffin, Waterford (IE); Paolo Antinori, Milan (IT); Andrea Cosentino, Milan (IT)

(21) Appl. No.: 18/817,964

(22) Filed: Aug. 28, 2024

(51) Int. Cl. G06N 10/80; H04L 9/40

(52) U.S. Cl. CPC G06N 10/80; H04L 63/10

(57) ABSTRACT

A first quantum service is registered. Registering the first quantum service comprises generating access policy information comprising a set of access criteria for the first quantum service. A service access request is received via a quantum channel to request access to the first quantum service from a first quantum entity. The service access request is indicative of requestor characteristics associated with the first quantum entity. A decision is made whether to grant the first quantum entity access to the first quantum service based on a comparison between the requestor characteristics and the set of access criteria.

### BACKGROUND

Quantum computing is an emerging technology that exploits quantum mechanical phenomena. Quantum computing systems can contain quantum services that utilize qubits, which are analogous to the bits used in classical computing. Qubits can be implemented using a variety of different quantum computing system services. Multiple quantum computing systems can communicate with one another using quantum channels that connect the quantum computing systems to allow use of quantum services from one quantum computing system for another quantum computing system.

### SUMMARY

Implementations described herein provide for dynamic access mediation for quantum services. More specifically, a quantum computing system can register a first quantum service of a plurality of quantum services by generating access policy information that includes a set of access criteria for the first quantum service. A service access request can be received that includes a plurality of requestor characteristics from a first quantum entity that indicates a request to access the first quantum service. The quantum computing system can make a decision whether to grant the first quantum entity access to the first quantum service based on comparison between the plurality of requestor characteristics and the set of access criteria for the first quantum service.

In one implementation, a method is provided. The method includes registering, by a quantum computing system comprising one or more processor devices, a first quantum service of a plurality of quantum services, wherein registering the first quantum service includes generating access policy information comprising a set of access criteria for the first quantum service. The method further includes receiving, by the quantum computing system via a quantum channel, a service access request to request access to the first quantum service from a first quantum entity, wherein the service access request is indicative of a plurality of requestor characteristics associated with the first quantum entity. The method further includes making, by the quantum computing system, a decision whether to grant the first quantum entity access to the first quantum service based on a comparison between the plurality of requestor characteristics and the set of access criteria for the first quantum service.

In another implementation, a quantum computing system is provided. The quantum computing system includes a memory and one or more processor devices coupled to the memory to register a first quantum service of a plurality of quantum services, wherein registering the first quantum service includes generating access policy information comprising a set of access criteria for the first quantum service. The one or more processor devices are further to receive a service access request to request access to the first quantum service from a first quantum entity, wherein the service access request is indicative of a plurality of requestor characteristics associated with the first quantum entity. The one or more processor devices are further to make a decision whether to grant the first quantum entity access to the first quantum service based on a comparison between the plurality of requestor characteristics and the set of access criteria for the first quantum service.

In another implementation, a non-transitory computer-readable storage medium is provided. The non-transitory computer-readable storage medium includes executable instructions configures to cause one or more quantum computing devices to register a first quantum service of a plurality of quantum services, wherein registering the first quantum service includes generating access policy information comprising a set of access criteria for the first quantum service. The one or more quantum computing devices are further to receive a service access request to request access to the first quantum service from a first quantum entity, wherein the service access request is indicative of a plurality of requestor characteristics associated with the first quantum entity. The one or more quantum computing devices are further to make a decision whether to grant the first quantum entity access to the first quantum service based on a comparison between the plurality of requestor characteristics and the set of access criteria for the first quantum service.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum service environment with dynamic access mediation for quantum services according to some implementations of the present disclosure.

FIG. 2 is a data flow diagram for a machine-learned model trained to dynamically generate access scoring adjustments based on outcomes of prior access decisions according to some implementations of the present disclosure.

FIG. 3 is a flowchart illustrating operations performed by the quantum computing system of FIG. 1 for dynamic access mediation for quantum services, according to one example.

FIG. 4 is a block diagram of the computing device of FIG. 1 for dynamic access mediation for quantum services, according to one example.

FIG. 5 is a block diagram of the quantum computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Quantum computing is an emerging technology that exploits quantum mechanical phenomena. Quantum computing systems can contain quantum services that utilize qubits, which are analogous to the bits used in classical computing. Qubits can be implemented using a variety of different quantum computing system services. Multiple quantum computing systems can communicate with one another using quantum channels that connect the quantum computing systems to allow use of quantum services from one quantum computing system for another quantum computing system.

In conventional quantum computing systems, quantum services on the quantum computing system can be shared amongst other quantum computing systems. Quantum resources, such as qubits, will be shared through a quantum channel to the quantum computing system that has accessed the quantum service. However, quantum computing systems can typically freely access services, and thereby pull resources, from other quantum computing systems without the quantum computing systems hosting the quantum service being able to limit or prevent access of the quantum service. This poses a problem for quantum computing systems, particularly when the quantum computing system is running at a high heat profile within the system from quantum services that are already being run. At sufficiently high temperatures, the qubits within the quantum computing system are exposed to thermal vibrations within the quantum computing system. These thermal vibrations can result in higher thermal noise and interfere with the quantum state of the qubits, leading to errors in quantum services that utilize those qubits.

This problem is exacerbated by the distributed nature of qubits and/or the quantum services that utilize such qubits. For example, a quantum entity may request access to a quantum service that utilizes a set of qubits to perform quantum tasks. Some requests to this quantum service can be fulfilled without substantially altering the environmental parameters of the set of qubits. However, some other requests to the quantum service can be known to substantially alter the environmental parameters (e.g., temperature, etc.) of the set of qubits of requested iteratively. In such instances, mediation is required to avoid degradation of qubit performance in quantum use-cases.

Accordingly, implementations described herein propose systems and methods for brokering quantum resources utilizing a quantum middleware mediation engine. For example, a quantum computing system can mediate (e.g., using the quantum mediation engine, etc.) access to one or more quantum services executing on the quantum computing system. To do so, the quantum computing system can register a first quantum service of a plurality of quantum services. To register the first quantum service, the quantum computing system can generate access policy information. The access policy information can describe an access policy for accessing the first quantum service. The access policy information can also include a set of access criteria for the first quantum service. For example, the access criteria can specify permitted uses, acceptable environmental parameters, usage duration, a number of requests permitted per entity, etc.

The quantum computing system can receive a service access request via a quantum channel. The service access request can be a request to access the first quantum service. The service access request can indicate one or more requestor characteristics associated with the first quantum entity. The requestor characteristic(s) can include information related to the first quantum entity (e.g., an identity of the first quantum entity, a location, previous requests received from the first quantum entity, etc.), or information related to the request itself (e.g., a type of request, a requested service, a duration of the request, etc.). Based on a comparison between the requestor characteristic(s) and the set of access criteria for the first quantum service, the quantum computing system can make a decision whether to grant the first quantum entity access to the first quantum service. In such fashion, implementations described herein can dynamically mediate access to quantum services based on characteristics of the request and/or the requestor.

Aspects of the present disclosure provide a number of technical effects and benefits. As one example technical effect and benefit, conventional approaches to quantum computing lack robust mediation systems to manage access to quantum services, and in turn, qubits utilized by such quantum services. Without effective mediation, quantum services can over-utilize qubits, leading to decoherence and similar effects that can substantially degrade qubit performance. However, implementations described herein enable dynamic mediation of access to quantum services with a quantum mediation engine. The quantum mediation engine can define access policies for quantum services that mitigate the risk of service overutilization, thus obviating a major cause of qubit performance degradation in conventional quantum use-cases.

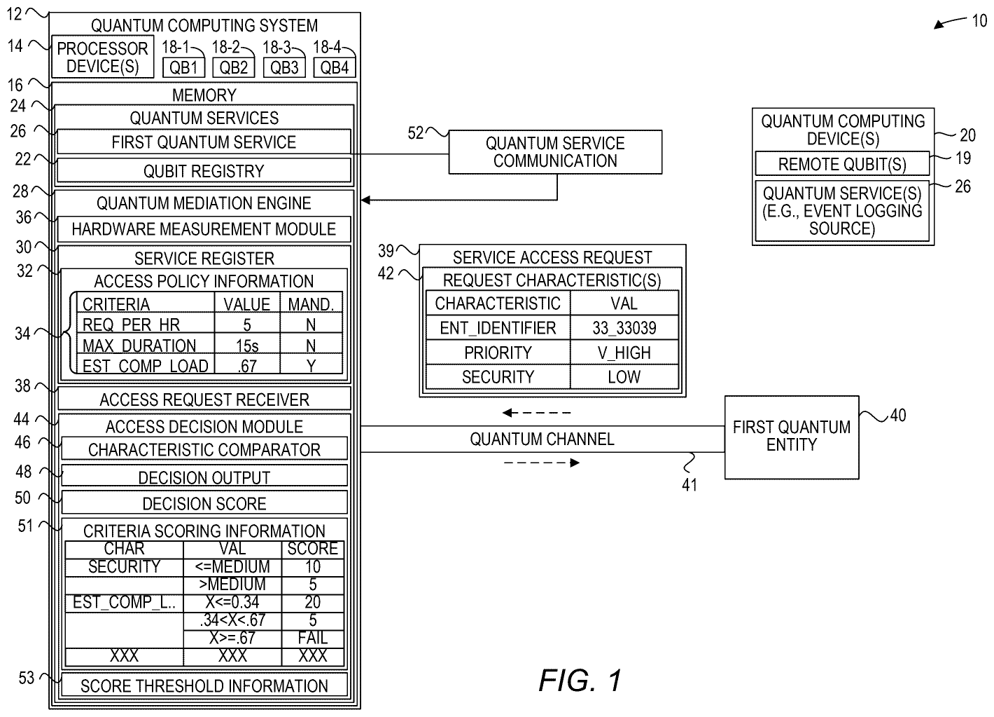

FIG. 1 is a block diagram of a quantum service environment 10 with dynamic access mediation for quantum services according to some implementations of the present disclosure. The quantum service environment 10 includes a quantum computing system 12 that includes processor device(s) 14 and a memory 16. The quantum computing system 12 can operate in the quantum service environment 10 but can operate using classical computing principles and/or quantum computing principles. The quantum computing system 12 can be any type or manner of computing device or network node, and can include physical computing device(s) (e.g., Central Processing Units (CPUs), Graphics Processing Units (GPUs), memory, accelerators, virtualized device(s) or service(s), etc. For example, the quantum computing system 12 can be a virtualized node within a cloud-based computing environment that has indirect access to computing resources through a virtualization layer.

The processor device(s) 14 of the quantum computing system 12 may include any computing or electronic device capable of executing software instructions to implement the functionality described herein. The memory 16 of the quantum computing system 12 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The quantum computing system 12 can implement, include, or otherwise access qubits 18-1-18-4 (generally, qubits 18). It should be noted that, in some implementations, one or more of the qubits 18 may be located on a quantum computing device or system located remotely from the quantum computing system 12. For example, qubits 18-1-18-2 may be components of, and located at, the quantum computing system 12. Qubits 18-3-18-4 may be located at quantum computing device(s) 20. For example, the quantum computing device(s) 20 can include remote qubit(s) 19 (e.g., a pair of qubits located at the same location, a distributed set of networked qubits located at different locations). The quantum computing device(s) 20 may allocate remote qubit(s) 19 to serve as one (or more) of the qubits 18. The remote qubit(s) 19 can process information remotely at the quantum computing device(s) 20, which may in turn communicate processed information to the quantum computing system 12 (e.g., via one or more networks, etc.). In such fashion, the quantum computing system 12 may increase a quantum processing capacity by leveraging remotely located qubits.

The quantum service environment 10 is a logical grouping, or clustering, of computing systems, devices, and/or resources. More specifically, the quantum service environment 10 is an environment in which a number of separate devices and/or systems share resources (e.g., hardware resources, compute cycles, services, etc.) via a central management framework that enforces consistent configuration and policies. It should be noted that the quantum service environment 10 can include any type or manner of computing device or system. For example, in some implementations, the quantum service environment 10 can include a number of quantum computing systems and classical computing systems. Additionally, in some implementations, the quantum service environment 10 can include quantum computing devices, such as quantum computing device(s) 20, that can implement and measure quantum processes. For example, the quantum computing device(s) 20 can include hardware and/or software resources that implement quantum processes by maintaining photon(s) in superposition.

The memory 16 of the quantum computing system 12 includes a qubit registry 22 that maintains state information about the qubits 18-1-18-4, including, by way of non-limiting example, a total qubits counter that identifies the total number of qubits 18 implemented by the quantum computing system 12, a total available qubits counter that maintains count of the total number of qubits 18 that are currently available for allocation, etc. In some implementations, the remote qubits can be located at different locations. For example, the quantum service(s) 26 can include a first quantum service implemented with a first set of the remote qubit(s) 19 located at a first geographic location, and a second quantum service implemented using a second set of the remote qubit(s) 19 located at a second geographic location different than the first geographic location.

The memory 16 of the quantum computing system 12 can include, or otherwise implement, a plurality of quantum services 24. As described herein, a quantum service refers to a service that receives a request, and in response, generates an output based at least in part on quantum information. For example, the quantum services 24 may directly interact with the qubits 18 and/or the remote qubit(s) 19 (e.g., observing the qubits, measuring a value of the qubits, etc.), and generate an output based on the interaction. For another example, the quantum services 24 may request that quantum information be retrieved from the qubits 18 and/or the remote qubit(s) 19 by another entity (e.g., another quantum service or device, etc.), and then generate an output based on the retrieved quantum information.

The quantum services 24 can be a service that at least partially utilizes quantum information (e.g., obtained from qubits, such as the qubits 18 and/or the remote qubit(s) 19, etc.) to generate an output. The quantum service(s) can include a first quantum service 26. The first quantum service 26 can be, or otherwise include, any type or manner of quantum service, such as the qubit registry 22, a random number generation service, etc.

Additionally, or alternatively, in some implementations, the quantum service(s) can be implemented via the quantum computing device(s) 20. To follow the previous example, rather than implementing the first quantum service 26 with the qubits 18, the quantum computing system 12 can orchestrate implementation of the first quantum service 26 in conjunction with the quantum computing device(s) 20 such that the first quantum service 26 is implemented using a mix of the qubits 18 and the remote qubits 19.

The memory 16 can include a quantum mediation engine 28. The quantum mediation engine 28 can be a program, application, collection of processes, etc. that is executed by the quantum computing system 12. The quantum mediation engine 28 can mediate access to the quantum services 26. In particular, the quantum mediation engine 28 can mediate access to the first quantum service 26. It should be noted that any steps, processes, operations, etc. described as being performed by the quantum mediation engine 28 can also be attributed to the quantum computing system 12 generally.

To do so, the quantum mediation engine 28 can first register the first quantum service 26 with the quantum mediation engine 28 using a service register 30. The service register 30 can register the first quantum service 26 with the quantum mediation engine 28. To do so, the service register 30 can generate access policy information 32. The access policy information 32 can describe an access policy for accessing the first quantum service. The access policy information 32 can include a set of access criteria 34 for the first quantum service. The set of access criteria 34 can include optional and/or mandatory criteria to be fulfilled in order for an access request to be granted. In some implementations, the quantum mediation engine 28 can receive at least one of the set of access criteria 34 for the first quantum service 26 from a computing device (e.g., the quantum computing device(s) 20, some other device, etc.) associated with the first quantum service 26 (e.g., a computing device associated with the same owning entity as the first quantum service 26).

To follow the depicted example, the set of access criteria 34 can include a “request per hour” criteria with a value of 5. If a request is received from a requesting entity that has already sent five previous requests in the past hour, the “request per hour” criteria will not be fulfilled. In some implementations, if certain access criteria are not fulfilled, the quantum mediation engine 28 can decide to deny access to the requesting entity. To follow the previous example, as the “request per hour” criteria is not indicated as a mandatory criteria (e.g., “MAND: Y”), the quantum mediation engine 28 would not necessarily deny an access request that does not fulfill that criteria.

For another example, the access criteria 34 can include a request duration criteria with a value of 15 seconds. For yet another example, the access criteria 34 can include an “estimated computational load” access criteria. The estimated computational load access criteria can indicate a degree of computational load, complexity, etc. associated with a request. For example, a request to generate random numbers would require a relatively small quantity of computing resources to fulfill, while a cryptographic request may require substantially more computing resources to fulfill.

In some implementations, the estimated computational load access criteria can be generated, or adjusted, based on the outcomes of prior or subsequent access requests for the first quantum service 26. For example, assume that the estimated computational load access criteria specifies a certain value, and performance degradation is subsequently caused by the first quantum service 26 due to a subsequent access request that meets the certain value for the estimated computational load access criteria. In this instance, the service register can dynamically reduce the value for the estimated computational load access criteria to mitigate further performance degradation.

It should be noted that the access criteria illustrated in FIG. 1 are non-limiting examples included to more clearly illustrate various implementations of the present disclosure. Any characteristic of a service access request, and/or the quantum entity sending the request, can be utilized as access criteria within the set of access criteria 34. Examples of the set of access criteria 34 can include a number of qubits to be utilized, a type of qubit to be utilized, a geographic location of the requestor, an estimated computational load, a maximum duration, etc.

In some implementations, the access policy information 32, and/or the set of access criteria 34, can indicate which qubits of the qubits 18 and/or remote qubit(s) 19 are utilized to implement certain services of the quantum services 24. For example, the access policy information 32 can indicate that the first quantum service 26 is implemented using qubits 18-1, 18-2, and 18-4. Additionally, or alternatively, in some implementations, the access policy information 32 can indicate that the qubits that might be used to implement the quantum services 24. For example, the access policy information 32 can indicate that the first quantum service 26 can be implemented using any (or all) of the qubits 18 and/or the remote qubit(s) 19.

In some implementations, the quantum mediation engine 28 can include a hardware measurement module 36. The hardware measurement module 36 can measure current environmental conditions at the qubits 18 and/or the remote qubit(s) 19. The set of access criteria 34 for the first quantum service 26 can include environmental conditions for the qubits 18 or the remote qubit(s) 19 used to implement the first quantum service 26 (as indicated by the access policy information 32). Fulfillment of the environmental conditions can be determined based on the measurements obtained by the hardware measurement module 36. For example, assume that the qubits 18 are a type of qubit that experiences degraded performance at high temperatures, or due to quantum noise, etc. The temperature of the qubits 18 can be measured (e.g., by the quantum computing system 12) regularly with the hardware measurement module 36, and the set of access criteria 34 can indicate a maximum temperature of the qubits 18. If the current temperature exceeds the maximum temperature, the quantum mediation engine 28 can deny access to the quantum services implemented using those qubits.

The quantum mediation engine 28 can include an access request receiver 38. The access request receiver 38 can receive service access requests for the quantum services 24. In particular, the access request receiver 38 can receive a service access request 39 from a first quantum entity 40. The first quantum entity 40. To do so, the access request receiver 38 can implement, or facilitate, a quantum channel 41 between the quantum computing system 12 and the first quantum entity 40. The quantum channel 41 can carry quantum and/or classical information between the first quantum entity 40 and the quantum computing system 12.

The service access request 39 can include request characteristics 42. In some implementations, the request characteristics 42 can be characteristics associated with the first quantum entity 40, or associated with the usage of the first quantum service 26 indicated by the service access request 39. For example, the request characteristics 42 can indicate an identity of the first quantum entity 40, prior requests sent by the first quantum entity 40, a location of the first quantum entity 40, previously granted access permissions, etc. Additionally, or alternatively, in some implementations, the request characteristics 42 can be characteristics of the service access request 39 itself. For example, the request characteristics 42 can indicate a requested function of the first quantum service 26, an estimated computational load, an estimated request duration, a degree of importance or time sensitivity associated with the service access request 39, a degree of security associated with the service access request 39, etc.

The quantum mediation engine 28 can include an access decision module 44. The access decision module 44 can make decisions whether to grant or deny service access requests received from quantum entities. More specifically, the access decision module 44 can make a decision whether to grant or deny the service access request 39 received from the first quantum entity 40. To do so, the access decision module 44 can include a characteristic comparator 46. The characteristic comparator 46 can compare the request characteristics 42 to the set of access criteria included in the access policy information 32 for the first quantum service 26.

In some implementations, the characteristic comparator 46 can generate a decision output 48 based on the comparison between the set of access criteria 34 and the request characteristics 42. The decision output 48 can grant or deny access to the first quantum service 26. In some implementations, the decision output 48 can grant access to the first quantum service 26 for a limited period of time. For example, assume that the set of access criteria 34 includes a security criteria with a maximum value of “medium”. The characteristic comparator 46 can determine that the “low” value for the security characteristic of the request characteristics 42 fulfills the security access criteria. The characteristic comparator 46 can then generate a portion of the decision output 48 based on the security characteristic fulfilling the security access criteria.

In some implementations, the characteristic comparator 46 can determine that a mandatory access criteria is not fulfilled by the request characteristics 42. If a mandatory access criteria is not fulfilled, the characteristic comparator 46 can cease further comparisons and generate a decision output 48 indicating denial of the service access request 39. Alternatively, the access criteria is not mandatory, and the characteristic comparator 46 can determine that a mandatory access criteria is not fulfilled by the request characteristics 42. The request characteristics 42 can also include requestor characteristics, and as such, may be referred interchangeably throughout as requestor characteristics 42. If a non-mandatory access criteria is not fulfilled, the characteristic comparator 46 can generate or modify the decision output 48.

Specifically, in some implementations, the decision output 48 can be based on a decision score 50. The decision score 50 can be calculated by the characteristic comparator 46. More specifically, in some implementations, the access decision module 44 can include criteria scoring information 51. The criteria scoring information 51 can assign a score (and/or scoring rules) to each of the non-mandatory criteria of the set of access criteria 34. The score provided by each criteria of the set of access criteria 34 that are fulfilled can be aggregated to generate the decision score 50. In some implementations, the score provided by a fulfilled access criteria can vary based on the degree to which the score is fulfilled. For example, if the set of access criteria 34 includes a maximum request duration criteria with a value of 15 seconds, the criteria scoring information 51 would indicate a smaller score for a service request with an estimated duration characteristic of 14 seconds than the score for another service request with an estimated duration characteristic of 4 seconds. In some implementations, the criteria scoring information 51 can be modified dynamically to adjust the score(s) for the access criteria associated with fulfillment of an access policy (and/or the degree to which the score varies) based on the outcomes of prior and/or subsequent access decisions.

For example, assume that the access decision module 44 generates the decision output 48 that grants the service access request 39. Further assume that a quantum service communication 52 is received from the first quantum service 26 indicating that the service access request 39 caused decoherence at the qubits 18 that implement the first quantum service 26. Based on the quantum service communication 52, the service register 30 can adjust the criteria scoring information 51 to reduce the scores associated with certain access credentials predicted to be associated with (or causative of) decoherence (e.g., request duration, estimated computational load, temperature, etc.).

To follow the depicted example, the set of access criteria 34 can include an “estimated computational load” access criteria that is a mandatory access criteria. The criteria scoring information 51 can indicate that an estimated computational load less than 0.34 can provide a score of 20, while an estimated computational load between 0.34 and 0.67 can provide a score of 5. An estimated computational load of 0.67 or higher can cause an automatic fail state due to a mandatory access criteria not being fulfilled. In such instances, the access decision module 44 can cease further evaluations and generate a decision output 48 indicating denial of the service access request 39.

In some implementations, the access decision module 44 can include score threshold information 53. The score threshold information 53 can include a threshold score. If the decision score 50 is greater than (or, in some implementations, equal to) the threshold score, the decision output 48 can indicate acceptance of the service access request 39. If the decision score 50 is less than the threshold score, the decision output 48 can indicate rejection of the service access request 39. The score threshold information 53 can also indicate specific thresholds (e.g., a threshold amount, threshold metric, etc.) for particular access criteria, such as an environmental threshold for an environmental condition access criteria. For another example, the score threshold information 53 can indicate an owner identity threshold (e.g., a particular identity or type of identity) for an identity access criteria.

In some implementations, the score threshold information 53 can be adjusted based on the outcomes of prior and/or subsequent decision outputs as described with regards to the criteria scoring information 51. For example, assume that the access decision module 44 grants the service access request 39 based on the decision score 50 being greater than the threshold score indicated by the score threshold information 53. Further assume that a quantum service communication 52 is received subsequently, which indicates that decoherence occurred due to the service access request 39. In some implementations, the access decision module 44 can identify certain criteria of the set of access criteria 34 that are likely causative of decoherence, and can reduce the scores associated with those criteria by modifying the criteria scoring information 51. Alternatively, in some implementations, the access decision module 44 can fail to identify certain criteria of the set of access criteria 34 that are likely causative of decoherence, and in response, can instead modify the score threshold information 53 to increase the threshold score.

The access decision module 44 can grant or deny the service access request 39 based on the decision output 48. In such fashion, implementations described herein can dynamically mediate access to quantum services via a quantum mediation engine that can be deployed to quantum devices within a quantum computing environment.

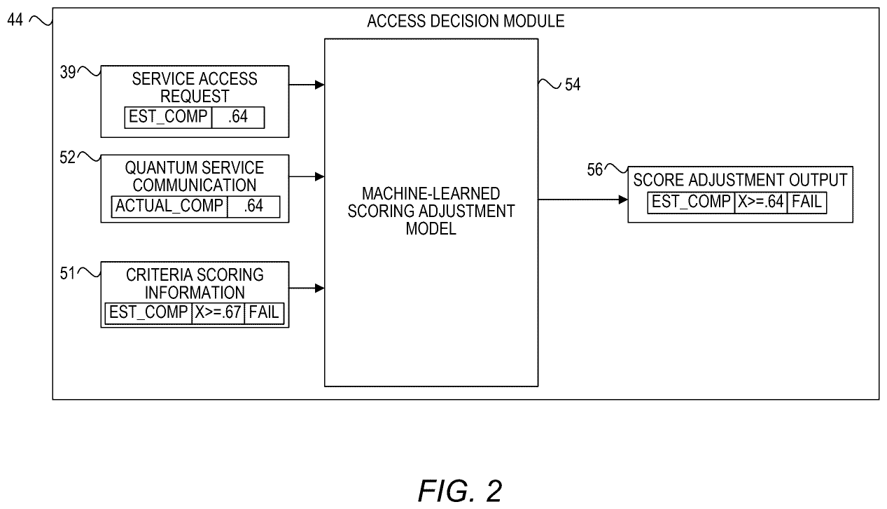

FIG. 2 is a data flow diagram for a machine-learned model trained to dynamically generate access scoring adjustments based on outcomes of prior access decisions according to some implementations of the present disclosure. FIG. 2 will be discussed in conjunction with FIG. 1. Specifically, in some implementations, the access decision module 44 can include a machine-learned scoring adjustment model 54. The machine-learned scoring adjustment model 54 can be any type or manner of machine-learned model, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In particular, the machine-learned scoring adjustment model 54 can be trained to generate a score adjustment output 56 that modifies the score threshold information 53, and/or the criteria scoring information 51, to reduce the likelihood of performance degradation caused by subsequent access decisions. For example, assume that the request characteristics 42 of the service access request 39, when compared to the set of access criteria 34, are provided a score higher than the threshold score indicated by the score threshold information 53. Further assume that the quantum service communication 52 indicates that decoherence occurred. If the machine-learned scoring adjustment model 54 cannot predict one of the set of access criteria 34 to be causative of decoherence, the machine-learned scoring adjustment model 54 can generate a score adjustment output 56 that modifies the criteria scoring information 51 to uniformly (and, in some instances, proportionally) reduce the scores provided by each of the set of access criteria 34 that were compared to generate the decision score.

To follow the depicted example, the criteria scoring information 51 indicates that an automatic fail state occurs if the estimated computational load is greater than 0.67 (e.g., some normalized computational load metric). The quantum service communication 52 indicates that decoherence occurred during fulfillment of the service access request 39. The service access request 39 includes a request characteristic that indicates an estimated computational load of 0.64, and the quantum service communication 52 indicates an actual computational load of 0.64 (e.g., the computational load measured during fulfillment of the service access request 39). In this instance, the machine-learned scoring adjustment model 54 can reduce the maximum value for the estimated computational load from 0.67 to 0.64.

In some implementations, the score adjustment output 56 can be utilized as a signal to train the machine-learned scoring adjustment model 54. For example, assume that the score adjustment output 56 is applied to the criteria scoring information 51. Further assume that additional quantum service communications (not illustrated) are received from the first quantum service 26 indicating that a rate of performance degradation has decreased following application of the score adjustment output 56. A loss function can be used to train the machine-learned scoring adjustment model 54 based on the score adjustment output 56 and the additional quantum service communications.

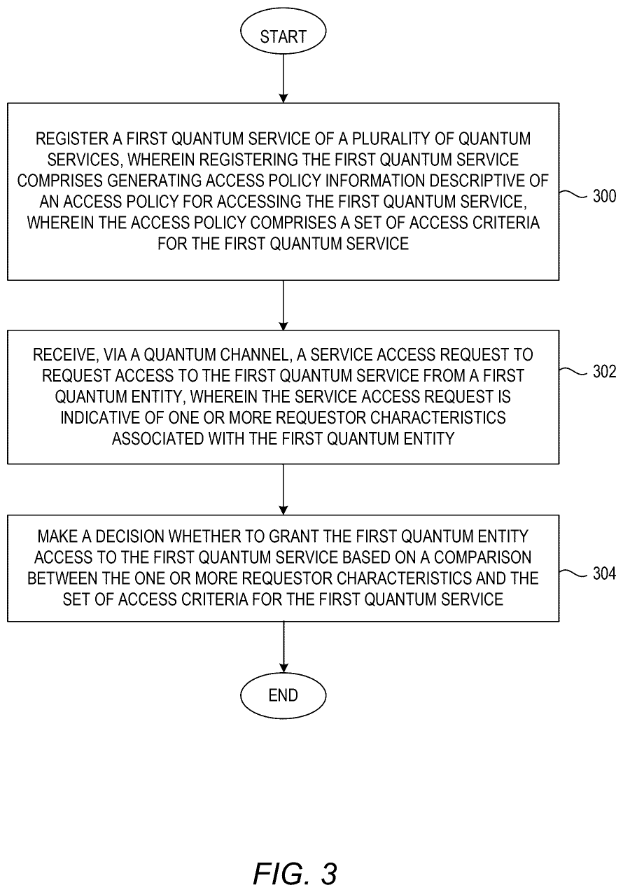

FIG. 3 is a flowchart illustrating operations performed by the quantum computing system of FIG. 1 for dynamic access mediation for quantum services, according to one example. Elements of FIG. 1 are referenced in describing FIG. 3 for the sake of clarity. In FIG. 3, operations begin with a processor device of a computing device, computing system, network node, etc., such as the processor device(s) 14 of the quantum computing system 12 of FIG. 1. The processor device(s) 14 are to register a first quantum service 26 of a plurality of quantum services 24, wherein registering the first quantum service comprises generating access policy information 32 descriptive of an access policy for accessing the first quantum service 26, wherein the access policy information 32 comprises a set of access criteria 34 for the first quantum service 26 (block 300). The processor device(s) 14 are further to receive, via a quantum channel 41, a service access request 39 to request access to the first quantum service 26 from a first quantum entity 40, wherein the service access request 39 is indicative of one or more requestor characteristics 42 associated with the first quantum entity 40 (block 302). The processor device(s) 14 are further to make a decision whether to grant the first quantum entity 40 access to the first quantum service 26 based on a comparison between the one or more requestor characteristics 42 and the set of access criteria 34 for the first quantum service 26 (block 304).

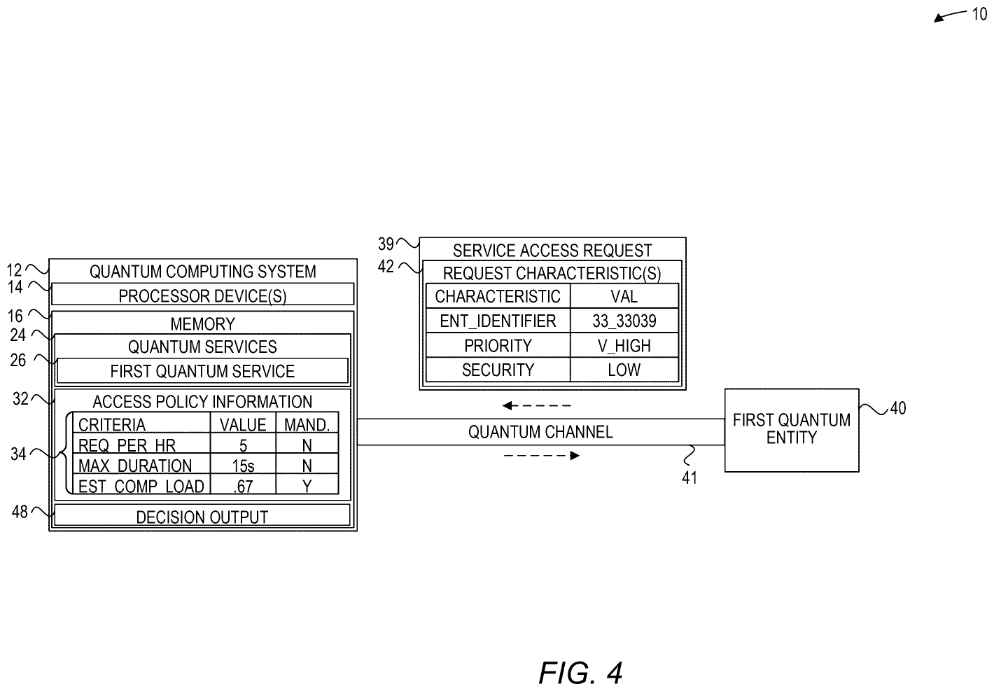

FIG. 4 is a block diagram of the computing device of FIG. 1 for dynamic access mediation for quantum services, according to one example. Elements of FIG. 1 are referenced in describing FIG. 4 for the sake of clarity. In the example of FIG. 4, the quantum computing system 12 includes a memory 16 and processor device(s) 14 coupled to the memory 16. The processor device(s) 14 are to register a first quantum service 26 of a plurality of quantum services 24. To register the first quantum service 26, the processor device(s) 14 are to generate access policy information 32 descriptive of an access policy for accessing the first quantum service 26, wherein the access policy information 32 comprises a set of access criteria 34 for the first quantum service 26. The processor device(s) 14 are further to receive, via a quantum channel 41, a service access request 39 to request access to the first quantum service 26 from a first quantum entity 40, wherein the service access request 39 is indicative of one or more requestor characteristics 42 associated with the first quantum entity 40. The processor device(s) 14 are further to make a decision (e.g., decision output 48) whether to grant the first quantum entity 40 access to the first quantum service 26 based on a comparison between the one or more requestor characteristics 42 and the set of access criteria 34 for the first quantum service 26.

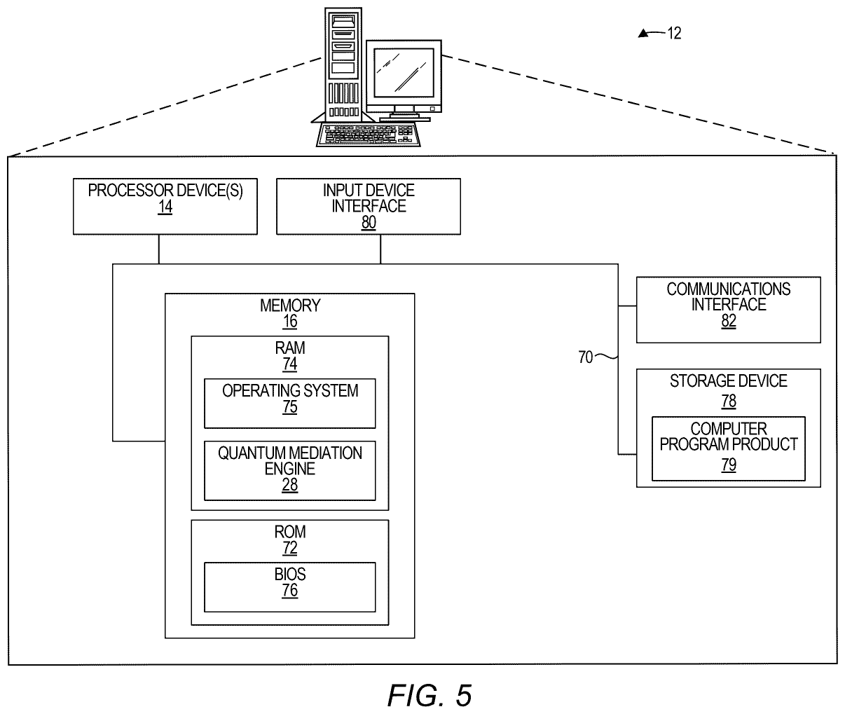

FIG. 5 is a block diagram of the quantum computing system 12 suitable for implementing examples according to one example. The quantum computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The quantum computing system 12 includes the processor device(s) 14, the memory 16, and a system bus 70. The system bus 70 provides an interface for system components including, but not limited to, the memory 16 and the processor device(s) 14. The processor device(s) 14 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The memory 16 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the quantum computing system 12. The volatile memory 74 may also include a high-speed RAM, such as static RAM, for caching data.

The quantum computing system 12 may further include or be coupled to a non-transitory computer-readable storage medium such as the storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 74, including an operating system 75 and one or more program modules, such as the quantum mediation engine 28, which may implement the functionality described herein in whole or in part. All or a portion of the examples may be implemented as a computer program product 79 stored on a transitory or non-transitory computer-usable or computer-readable storage medium, such as the storage device 78, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the quantum mediation engine 28 in the volatile memory 74, may serve as a controller, or control system, for the quantum computing system 12 that is to implement the functionality described herein.

Because the quantum mediation engine 28 is a component of the quantum computing system 12, functionality implemented by the quantum mediation engine 28 may be attributed to the quantum computing system 12 generally. Moreover, in examples where the quantum mediation engine 28 comprises software instructions that program the processor device(s) 14 to carry out functionality discussed herein, functionality implemented by the quantum mediation engine 28 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The quantum computing system 12 may also include a communications interface 82 suitable for communicating with a network as appropriate or desired. The quantum computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
registering, by a quantum computing system comprising one or more processor devices, a first quantum service of a plurality of quantum services, wherein registering the first quantum service comprises generating, by the quantum computing system, access policy information comprising a set of access criteria for the first quantum service;
receiving, by the quantum computing system via a quantum channel, a service access request to request access to the first quantum service from a first quantum entity, wherein the service access request is indicative of a plurality of requestor characteristics associated with the first quantum entity; and
making, by the quantum computing system, a decision whether to grant the first quantum entity access to the first quantum service based on a comparison between the plurality of requestor characteristics and the set of access criteria for the first quantum service.

2. The method of claim 1, wherein generating the access policy information comprises:
receiving, by the quantum computing system, at least one of the set of access criteria for the first quantum service from a computing device associated with the first quantum service.

3. The method of claim 1, wherein at least one of the plurality of quantum services comprises a qubit registry that maintains state information for a set of qubits located on one or more quantum computing systems.

4. The method of claim 3, wherein the first quantum service is the qubit registry.

5. The method of claim 1, wherein the service access request is further indicative of a plurality of request characteristics associated with a usage of the first quantum service indicated by the service access request.

6. The method of claim 1, wherein the plurality of requestor characteristics comprises an owner identity of the first quantum entity.

7. The method of claim 1, wherein the plurality of requestor characteristics comprises a number of requests received from the first quantum entity; and
wherein making the decision whether to grant access comprises:
determining, by the quantum computing system, that the number of requests received from the first quantum entity is less than a threshold number of requests.

8. The method of claim 1, further comprising:
receiving, by the quantum computing system via the quantum channel, one or more measurements comprising at least one of:
a temperature associated with the quantum computing system; or
quantum noise associated with the quantum computing system; and
wherein making the decision whether to grant access comprises:
determining, by the quantum computing system, that the temperature associated with the quantum computing system and the quantum noise associated with the quantum computing system are less than an environmental threshold.

9. The method of claim 1, wherein making the decision whether to grant access comprises:
determining, by the quantum computing system, to grant the first quantum entity access to the first quantum service.

10. The method of claim 9, wherein determining to grant the first quantum entity access comprises:
determining, by the quantum computing system, to grant the first quantum entity access to the first quantum service for a limited period of time.

11. The method of claim 9, further comprising:
granting, by the quantum computing system, the first quantum entity access to the first quantum service via the quantum channel.

12. The method of claim 1, wherein the set of access criteria comprises at least one of:
a degree of security associated with the service access request;
an estimated computational load associated with fulfillment of the service access request;
a degree of time sensitivity associated with the service access request; or
a temperature of a qubit that implements the first quantum service.

13. The method of claim 1, wherein making the decision whether to grant access comprises:
determining, by the quantum computing system, to deny the first quantum entity access to the first quantum service.

14. A quantum computing system comprising:
a memory; and
one or more processor devices coupled to the memory to:
register a first quantum service of a plurality of quantum services, wherein registering the first quantum service comprises generating access policy information comprising a set of access criteria for the first quantum service;
receive a service access request to request access to the first quantum service from a first quantum entity, wherein the service access request is indicative of a plurality of requestor characteristics associated with the first quantum entity; and
make a decision whether to grant the first quantum entity access to the first quantum service based on a comparison between the plurality of requestor characteristics and the set of access criteria for the first quantum service.

15. The quantum computing system of claim 14, wherein, to generate the access policy information, the one or more processor devices are to:
receive at least one of the set of access criteria for the first quantum service from a computing device associated with the first quantum service.

16. The quantum computing system of claim 14, wherein at least one of the plurality of quantum services comprises a qubit registry that maintains state information for a set of qubits located on a plurality of quantum computing systems.

17. The quantum computing system of claim 16, wherein the first quantum service is the qubit registry.

18. The quantum computing system of claim 14, wherein the service access request is further indicative of a plurality of request characteristics associated with a usage of the first quantum service indicated by the service access request.

19. The quantum computing system of claim 14, wherein the plurality of requestor characteristics comprises an owner identity of the first quantum entity.

20. A non-transitory computer-readable storage medium that includes executable instructions configured to cause one or more quantum computing devices to:
register a first quantum service of a plurality of quantum services, wherein registering the first quantum service comprises generating access policy information comprising a set of access criteria for the first quantum service;
receive a service access request to request access to the first quantum service from a first quantum entity, wherein the service access request is indicative of a plurality of requestor characteristics associated with the first quantum entity; and
make a decision whether to grant the first quantum entity access to the first quantum service based on a comparison between the plurality of requestor characteristics and the set of access criteria for the first quantum service.
